(19) United States
(12) Patent Application Publication
(10) Pub. No.: US 2001/0018684 A1
(43) Pub. Date: Aug. 30, 2001

(54) System and method for accessing non-relational data by relational access methods

(75) Inventors: Wilhelm Mild, Boeblingen (DE); Ingo Franzki, Schoenaich (DE)

Correspondence Address: William A. Kinnaman, Jr., IBM Corporation, 2455 South Road (M/S P386), Poughkeepsie, NY, 12601, US

(73) Assignee: International Business Machines Corporation, Armonk, NY (US)

(21) Appl. No.: 09/791,924

(22) Filed: Feb. 23, 2001

(30) Foreign Application Priority Data
Feb. 25, 2000 (DE) 00103965.0

(51) Int. Cl. G06F 7/00

(52) U.S. Cl. 707/1

(57) ABSTRACT

The present invention relates to a system and method for accessing non-relational data stored in records on a host system by a relational access method. The implementation of a relational interface component allows data transformation and type conversion and gives a relational interface to non-relational data. An integrated mapping component is used to define the relational structure of non-relational records or data. This relational structure is used by the application program or database request. The mapping component allows one to define columns with their characteristic (i.e. byte offset, data type, length). The definitions can be grouped in maps equivalent to a relational table and views representing a subset of the columns defined in a map. Multiple different maps and views can be defined for one record. The information of the maps, columns and views are stored in a repository. The inventive interface component uses the definitions stored in the repository to access the non-relational data and splits the records. Preferably based on the SQL language non-relational data like VSAM data can be accessed from any program using the relational interface component. The original non-relational data remains unchanged and older programs work without changes. The present invention gives new possibilities for host based programs using non-relational access methods and supports the integration, transition and migration into relational environments.

### BACKGROUND OF THE INVENTION

1. Field of the Invention

The present invention relates to a system and method for accessing non-relational data stored in records on a host system. More specifically the present invention relates to a system and method for accessing non-relational data or records by means of relational application programs or relational access methods.

2. Description of the Related Art

Application programs in host environments use access methods for reading and writing data. Many host operating systems, especially the IBM VSE/ESA operating system, offer non-relational access methods (IBM VSAM). Non-relational access methods do not use or take care of any structure within the record except a key path. Each application program using such records or data needs to define its own view for the data managed by the non-relational access method. Different programs use different methods to manage the structure for storing data. Therefore, developer of application programs needs special knowledge about the operating system for writing records into a storage medium.

In today's IT environments, standard interfaces become more and more important for application developers. In e-business applications the standard interfaces for relational databases like ODBC and the IBM DB2 Call Level Interface are well known and used for data access.

Application programs using a standardized interface for relational databases are unable to access records stored in a non-relational way.

In the client/server environment independent software vendors offer a client/server architecture allowing access to non-relational managed records or data by application programs designed to access relational managed records or data only. A disadvantage of such an architecture is that the client as well the server requires additional programs for achieving the communication between the relational application program stored on the client site and the non-relational access method stored on the server site. Furthermore, each client system requires its own program. Finally, programs installed on the server as well on the client need the same version.

### SUMMARY OF THE INVENTION

It is therefore an object of the present invention to provide a system and method for accessing non-relational records or data by programs using relational access methods avoiding the disadvantages of the prior art systems.

This object is solved by the features of the independent claims. Further embodiments of the invention are laid down in the subclaims.

The inventive method for accessing non-relational data stored in records by means of programs using relational access methods starts with the step of gathering information that describes the non-relational data structure of the record. Preferably, this information is obtained from source code of the program (e.g., a COBOL copybook or a C header file). After having this non-relational structure of the record, at least one map for each record is generated that maps the non-relational data structure into a relational data structure having columns and rows. The maps are stored in a storage medium, e.g. a repository. A further embodiment of the present invention allows one to generate views that are based on the map information. Each view includes a subset of the columns defined in the map.

An interface component is implemented for receiving relational requests and executing them. The interface component accesses the map specified in the relational request, retrieves column information for accessing the data element from the map and generates an optimized non-relational request using column information for accessing the data element. The optimized non-relational request is executed via a non-relational access method.

By the implementation of the host side interface accesses to non-relational data can be made via standardized commands like SQL. The integration, transition and migration from the non-relational into relational environment is accomplished without requiring additional program products or adaptions of the original non-relational data.

### BRIEF DESCRIPTION OF THE DRAWINGS

The present invention will be described in more detail by a preferred embodiment of the present invention in connection with accompanied drawings in which:

FIG. 1 shows a prior art host system using non-relational data.

FIG. 2 shows an example for mapping a non-relational record into relational view according to the present invention.

FIG. 3 shows an example for generating a column based on the record structure as shown in FIG. 2 according to the present invention.

FIGS. 4A-4D show the inventive method for generating maps and views based on the record structure as shown in FIG. 2.

FIG. 5 shows the inventive interface architecture for mapping non-relational record structure into a relational view.

FIG. 6 shows the inventive method for accessing non-relational data by programs using relational access methods.

### DESCRIPTION OF THE PREFERRED EMBODIMENTS

The implementation of an inventive relational interface (e.g. VSAMSQL) component allows data transformation and type conversion and gives a relational interface to non-relational data.

An integrated mapping component is used to define the relational structure of non-relational records or data. This relational structure is used by the application program or database request.

The mapping component allows one to define columns with their characteristics (i.e. byte offset, data type, length). The definitions can be grouped into maps equivalent to a relational table and views representing a subset of the columns defined in a map. Multiple different maps and views can be defined for one record.

The information of the maps, columns and views are stored in one repository. The inventive interface uses the definitions stored in the repository to access the non-relational data and splits the records.

Preferably based on the SQL language non-relational data like VSAM data can be accessed from any program using the relational interface component.

The original non-relational data remains unchanged and older programs work without

changes. The present invention allows access to non-relational managed data or records in a relational manner (in tables/maps and views) by standardized requests like SQL commands using the inventive relational interface component (e.g. VSAMSQL).

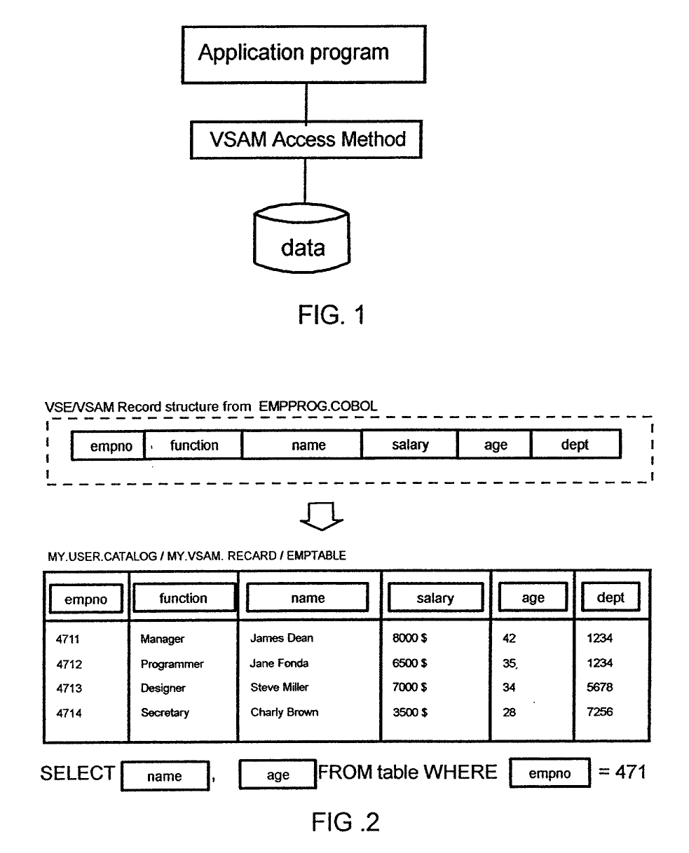

FIG. 1 shows a host system using non-relational data. The host system contains a operating system that provides a non-relational access method for writing and reading data. Non-relational access methods do not use or take care of any structure within the record except a key path. Each program using such records or data needs to define its own view for the data managed by the non-relational access method. Different programs use different methods to manage the structure for storing data.

FIG. 2 shows a VSAM record structure EMPPROG.COBOL. The VSAM data has a non-relational structure. The record consists of the data elements, e.g. data empno (=employee number), function, name (=employee name), salary, age, dept (department). Only the application program itself knows the order, length and structure of each data element stored in the record.

Each record structure is transformed into a relational view. In the preferred embodiment of the present invention the relational view is defined by rows and columns. The data contained in the VSAM record must be transformed in a column and row view representation. For example the columns are defined by employee number, function, name, salary, age and department. Each row within each column contains data concerning a certain employee. The relational representation which is mainly used in relational databases is accessed by SQL requests. SQL requests may be created by specifying a certain column from a certain table with a selected row, e.g. select “name, age (column)” from table EMPTABLE where empno=471(row). The SQL requests are sent to the VSAM interface component VSAMSQL.

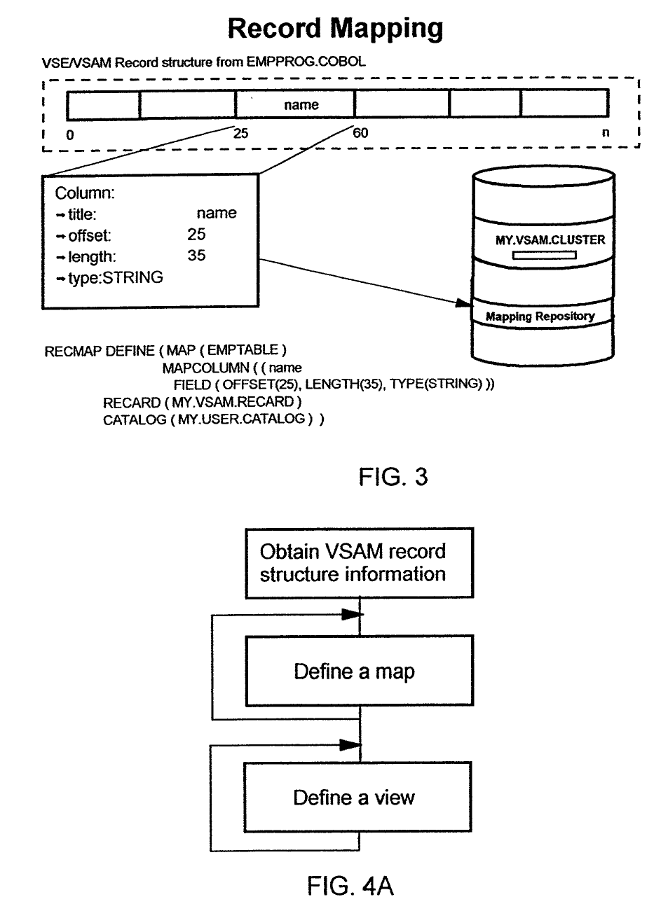

FIG. 3 shows in detail how a column according to FIG. 2 is generated. Each VSAM record consists of several data elements that are defined by title, offset, length and type.

Each data element that is to be addressable is defined as a column. For example the data element with the offset 25, length 35, type: string, title: name will be defined as a column and is stored in a mapping repository. The column is accessible over MAP name EMPTABLE.

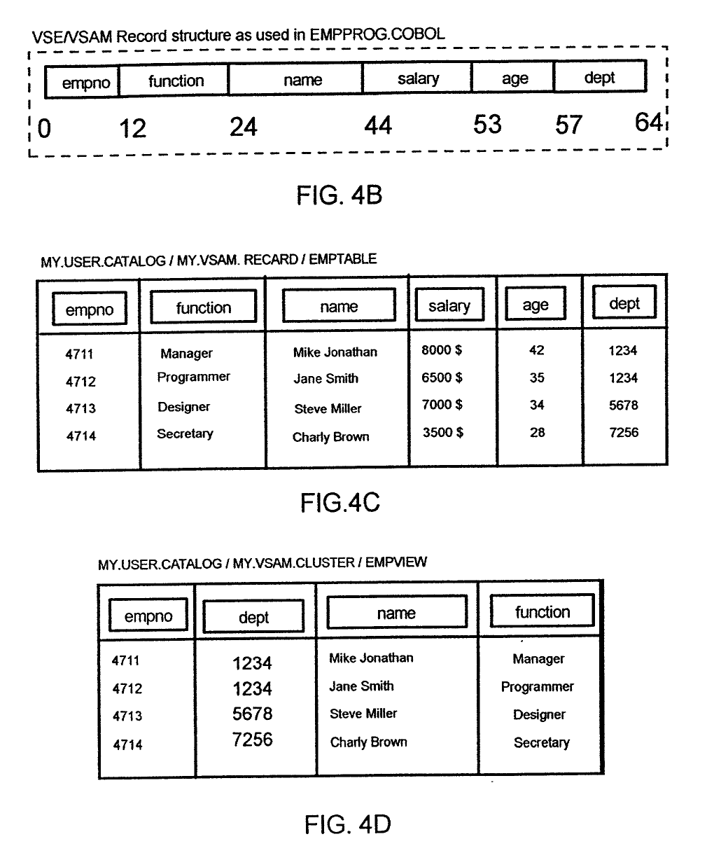

FIG. 4A shows a method for generating maps and views according to the present invention based on the record structure as shown in FIG. 2. To enable the work with VSAM data via the new inventive interface VSAMSQL, the process of structuring/mapping data must be done first. This step, also called record mapping, defines the structure of the VSE/VSAM record and stores it in the mapping repository. (In a relational database such information is stored in the database directory). Each part of a VSAM record that is to be addressable as an independent data element via the VSAMSQL interface is defined as a column in a so-called map via the system-integrated mapping utility RECMAP. A column definition contains the title of the column, the offset within the record, the length of the field and the data type (e.g. STRING, INTEGER). The characteristics for the columns are stored in the mapping repository. A map can contain one or more columns related to one VSAM record. However multiple maps can be defined for one VSAM record. To use only a part of the columns defined in a map the construct of a view is used. A view contains a subset of the columns defined in a map. Also multiple views can be defined for a map. For example the view may contain name and salary or name and function or name, function and age.

FIG. 4B shows a sample VSAM record (non-relational record) that is mapped according to the present invention supported by the RECMAP utility as follows. With the RECMAP utility a map is defined with the name EMPTABLE for the structure of FIG. 4B that contains the following columns:

empno field (offset (0), length (12), type (integer)

function field (offset (12), length (12), type (string)

name field (offset (24), length (20), type (string)

salary field (offset (44), length (9), type (integer)

age field (offset (53), length (4), type (integer)

dept field (offset (0), length (12), type (packed).

This information is stored in the mapping repository and is used by the VSAMSQL interface.

The result is a logical relational table accessible via the VSAMSQL interface using the information stored in the mapping repository as shown above (see FIG. 4C).

Based on the sample of FIG. 4C a view is defined as follows. Supported by the RECMAP utility a view is defined with the name EMPVIEW based on the map EMPTABLE which contains a subset of the columns defined in the map as follows:

RECMAP DEFINE (MAP(EMPTABLE) VIEW(EMPVIEW)

VIEWCOLUMN(empid, REFCOLUMN(empno))

VIEWCOLUMN(department, REFCOLUMN(dept))

VIEWCOLUMN(FIRST NAME, REFCOLUMN(name))

VIEWCOLUMN(function, REFCOLUMN(function))

Views may be defined according to the system's requirements.

The result is a logical relational view, accessible via the VSAMSQL interface using the information stored in the mapping repository (see FIG. 4D).

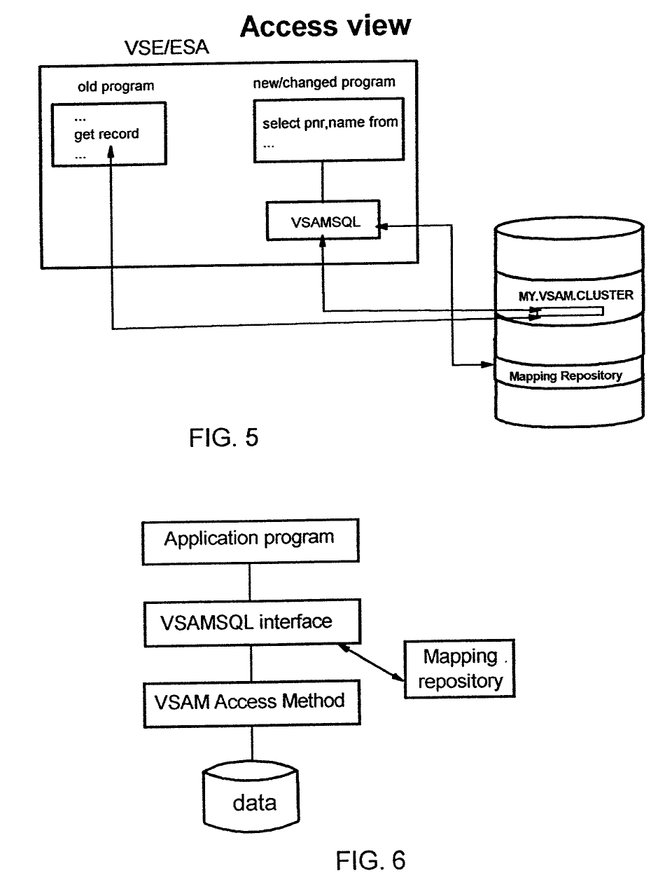

FIG. 5 shows the access view to VSAM data by using the inventive VSAMSQL interface in the IBM VSE/ESA environment. The original VSAM data remains unchanged, older programs work without changes. The VSAMSQL interface uses the same VSAM data, but the access is done on a column level. The interface is able to do data transformation and type conversion. Based on the SQL language VSAM data can be accessed from any VSE/ESA program using the VSAMSQL interface. The VSAMSQL interface is preferably based on the DB2 CLI standard interface. When a new program issues SQL statements against VSAM data the VSAMSQL interface translates the SQL statement into VSE/VSAM requests. Together with the mapping definitions from the mapping repository it splits the record into predefined columns. Then the columns are accessed independently of each other. All VSAM related logic is handled internally and is completely hidden from the programming interface. Additionally the requests are optimized for VSAM specifications, for example by automatically selecting the best index key.

FIG. 6 shows the inventive method for accessing non-relational data by programs using a relational access method.

The application program designed to relational access methods uses for example a dynamic SQL request with the prefix VSAMSQL to redirect the request to the inventive interface VSAMSQL.

The VSAMSQL interface analyses the request, accesses the mapping repository that contains the maps and views, identifies the selected map or view, retrieves the column information (offset, length) from the selected map or view, generates an optimized VSAM request and executes the optimized VSAM request using the VSAM access method.

What is claimed is:

1. A method for accessing data stored in records having a non-relational data structure by means of a program using a relational access method, each of said records containing at least one data element, said method comprising the steps of:
gathering information that describes the non-relational data structure of said records;
generating a map that maps said non-relational data structure to a relational data structure having columns and rows;
storing said map in a storage medium; and
receiving a relational request specifying a map and executing said request using an interface component that performs the steps of:
accessing the map specified in said relational request to retrieve column information for accessing said data element from said map;
generating an optimized non-relational request using column information for accessing said data element; and
executing said optimized non-relational request via a non-relational access method.

2. A method according to claim 1, wherein said non-relational structure information is obtained from source code.

3. A method according to claim 1, wherein said non-relational structure information is obtained from a COBOL copybook.

4. A method according to claim 1, wherein said non-relational structure information is obtained from a C header file.

5. A method according to claim 1, further comprising the steps of:
generating a view based on said map that includes a subset of the columns defined in said map; and
storing said view in a storage medium.

6. A method according to claim 5, wherein said step of generating a map and said step of generating a view are automatically performed by a mapping tool.

7. A method according to claim 5, wherein said map and said view are stored in a mapping repository.

8. A method according to claim 1, wherein each defined addressable data element in a record is defined as a separate column.

9. A method according to 1, wherein each column is defined by an arbitrary name for the column, offset within the record, length of field in the record and data type.

10. A method according to claim 1, wherein each record or part thereof is defined in multiple maps.

11. A method according to claim 1, wherein each map or part thereof is defined in multiple views containing a subset of columns defined in the map.

12. A method according to claim 1, wherein said relational request is a SQL request that is specified by one or more columns and the name of a related map or view.

13. A computer program product containing software code for executing the method of claim 1 when said program product is run on a digital computer.

14. A method for accessing data stored in records having a non-relational data structure that includes at least one data element by means of a program using a relational access method, each record or part thereof being defined in a map in a relational view having columns and rows, said method comprising the steps of:
receiving a relational request specifying a map and executing said request using an interface component that performs the following steps:
accessing the map specified in said relational request;
retrieving column information for accessing said data element from said map;
generating an optimized non-relational request using said column information for accessing said data element; and
executing said optimized non-relational request via a non-relational access method.

15. A computer program product containing software code for executing the method of claim 14 when said program product is run on a digital computer.

16. A system for accessing data stored in records having a non-relational data structure via a program using a relational access method, comprising:
a repository containing a map or view that maps said non-relational data structure to a relational data structure having columns and rows; and
an interface component for mapping relational requests from said program to non-relational requests by means of information from said repository.

17. A method for mapping a non-relational data structure of a record to a relational data structure, comprising the steps of:
gathering information that describes the non-relational data structure of said record;
generating a map that maps said non-relational data structure to a relational data structure having columns and rows; and
storing said map in a storage medium.

18. A method according to claim 17, further comprising the steps of:
generating a view based on said map that includes a subset of data elements defined in said map; and
storing said view in a storage medium.

19. A computer program product containing software code for executing the method of claim 18 when said program product is run on a digital computer.
